(19) United States
(12) Patent Application Publication
(10) Pub. No.: US 2017/0156440 A1
(43) Pub. Date: Jun. 8, 2017

(54) COMPOSITE SHOE SOLE AND METHOD FOR MAKING THEREOF

(71) Applicant: Zhenyu GUO, GUANGZHOU (CN)

(72) Inventor: Zhenyu GUO, GUANGZHOU (CN)

(21) Appl. No.: 15/194,539

(22) Filed: Jun. 27, 2016

(30) Foreign Application Priority Data
Dec. 4, 2015 (CN) 201510889300.4

(51) Int. Cl. A43B 13/12; A43B 13/14; B29C 45/00; B29B 7/02; B29B 13/06; A43B 13/04; A43B 13/22

(52) U.S. Cl. CPC A43B 13/12; A43B 13/04; A43B 13/141; A43B 13/22; B29B 7/02; B29B 13/06; B29C 45/0001; B29K 2105/089

(57) ABSTRACT

A composite shoe sole having an outsole which is made of rubber, plastic or thermoplastic rubber (TPR), and a plurality of small pieces of fabrics filled inside the outsole; the outsole and the plurality of small pieces of fabrics are injection-molded and integrally formed. A method of making the composite shoe sole is also disclosed. The composite shoe sole allows the shoe sole to have good flex resistance when flexed thanks to the small pieces of fabrics filled inside the outsole. The small pieces of fabrics also provide good puncture resistance to the shoe sole, thus increasing the usage life of the shoe sole. Also, the shoe sole is lighter and cost is reduced. When transparent material is used for making the outsole, the small pieces of fabrics inside the outsole can render the whole shoe sole a visual effect different from conventional shoe soles.

### BACKGROUND OF THE INVENTION

The present invention relates to a composite shoe sole and method for making thereof.

Shoe soles constitute an important part of shoes. During the use of shoes, since the flexing of foot soles produces stress, shoe soles may gradually appear to be out of shape or even develop cracks. Meanwhile, cutting or piercing of shoe soles by sharp objects may also result in the cracking, breaking or puncture of shoe soles.

Thus, the flex-resistant and puncture-resistant ability of shoe soles are important factors affecting the life of shoes.

### BRIEF SUMMARY OF THE INVENTION

The present invention aims at providing a composite shoe sole which is light and low in cost with good flex resistance and puncture resistance to increase the usage life of shoe soles, and to provide a method for making thereof.

To achieve the aforesaid aims, the technical scheme adopted by the present invention is as follows:

A composite shoe sole, comprising an outsole which is made of rubber, plastic or thermoplastic rubber (TPR), and a plurality of small pieces of fabrics filled inside the outsole; the outsole and the plurality of small pieces of fabrics are integrally formed.

Preferably, a weight ratio of the small pieces of fabrics to the outsole is 1:(1-9).

Preferably, the small pieces of fabrics are strip-shaped; the plurality of small pieces of fabrics are provided along a lengthwise direction of the outsole.

Preferably, each of the small pieces of fabrics is 0.7 cm-1.5 cm long and 0.4 mm-0.6 mm wide.

Preferably, the small pieces of fabrics are made of a large piece of fabrics being crushed by a crusher.

A method of making a composite shoe sole includes the following steps:

1) Selecting a large piece of fabrics, and selecting rubber materials, plastic materials or thermoplastic rubber (TPR) materials, wherein a melting point of the large piece of fabrics is higher than that of the rubber materials, plastic materials or thermoplastic rubber (TPR) materials; and dividing the large piece of fabrics into a plurality of small pieces of fabrics;

2) Weighing the small pieces of fabrics by weight percentage and weighing rubber materials, plastic materials or thermoplastic rubber (TPR) materials by weight percentage; and obtaining a mixture of the small pieces of fabrics and the rubber materials, plastic materials or thermoplastic rubber (TPR) materials through sufficient mixing by using a mixer;

3) Using the mixture to make a shoe sole by injection molding through an injection molding machine.

Preferably, the rubber materials, plastic materials or thermoplastic rubber (TPR) is/are subject to a drying process before injection molding, and moisture content is measured; a weight percentage of moisture content is required to be 5% or less.

Preferably, the mixture is poured into a mold through an injection molding machine; a temperature of a material canister of the injection molding machine is 160° C.˜210° C.; a temperature of a nozzle of the injection molding machine is 180° C.˜230° C.; a temperature of the mold cavity is 30˜40° C.

Preferably, the large piece of fabrics are placed in the crusher which operates after setting parameters of the crusher to divide the large piece of fabrics into a plurality of small pieces of fabrics.

The composite shoe sole provided in the present invention allows the shoe sole to have good flex resistance when flexed thanks to the small pieces of fabrics filled inside the outsole. Meanwhile, the small pieces of fabrics provide good puncture resistance to the shoe sole. The usage life of shoe soles is significantly increased. At the same time, the shoe sole is lighter. Cost is effectively reduced as well. Also, when transparent outsole materials are used, the small pieces of fabrics inside the outsole can render the whole shoe sole a visual effect different from conventional shoe soles.

### BRIEF DESCRIPTION OF THE DRAWINGS

The accompanying drawings described herein are provided for further understanding of the present invention, and constitute a part of the present application, and do not intend to unduly limit the present invention. In the accompanying drawings:

FIG. 1 is a schematic structural diagram showing a horizontal sectional view of the shoe sole according to embodiment 1 of the present invention;

FIG. 2 is a schematic structural diagram showing a vertical sectional view of the shoe sole according to embodiment 2 of the present invention.

### DETAILED DESCRIPTION OF THE INVENTION

The present invention is described in detail below in conjunction with the accompanying drawings and specific embodiments. The exemplary embodiments and descriptions of the present invention are provided herein for explanation of the present invention but not limitations thereto.

### Embodiment 1

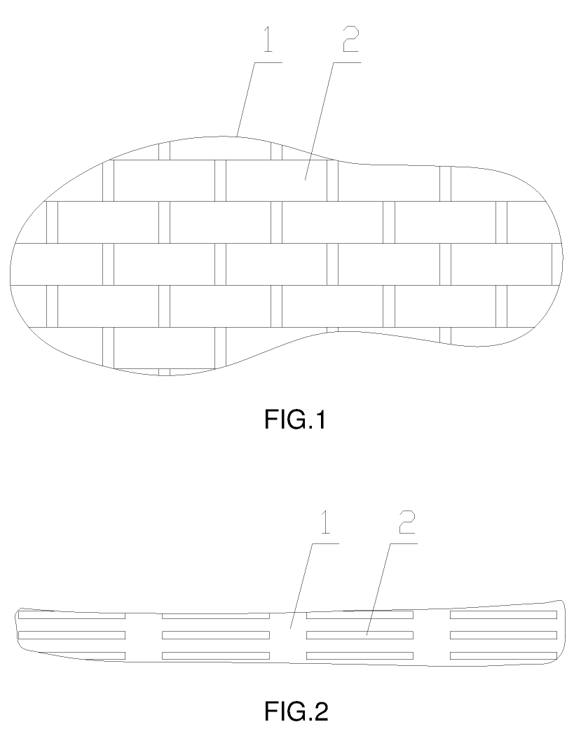

As shown in FIG. 1, a composite shoe sole comprises an outsole 1 made of rubber, plastic or thermoplastic rubber (TPR) through injection molding, and a plurality of small pieces of fabrics 2 integrally formed and filled inside the outsole 1, wherein the small pieces of fabrics 2 are large piece of fabrics being crushed by a crusher, and a weight ratio of the small pieces of fabrics 2 to the outsole is 1:1. In this embodiment, the small pieces of fabrics 2 are distributed horizontally inside the outsole 1. When the shoe sole is flexed because of walking, the stress concentrates on the small pieces of fabrics 2, thereby reducing the extent of deformation of the outsole 1. Cutting or piercing of shoe soles by sharp objects can also be effectively prevented, thereby improving the flex-resistance and puncture-resistance capability of shoe soles. From a bottom view of the shoe sole (i.e. a view of the shoe sole projected from outside to inside), the small pieces of fabrics 2 cover about 90% of a bottom surface area of the outsole 1.

### Embodiment 2

As shown in FIG. 2, a composite shoe sole comprises an outsole 1 which is made of rubber, plastic or thermoplastic rubber (TPR) through injection molding, and a plurality of small pieces of fabrics 2 integrally formed and filled inside the outsole 1, wherein the small pieces of fabrics 2 are a large piece of fabrics being crushed by a crusher, and a weight ratio of the small pieces of fabrics 2 to the outsole 1 is 1:9. In this embodiment, the small pieces of fabrics 2 are distributed vertically inside the outsole 1. When the shoe sole is flexed because of walking, the stress concentrates on the small pieces of fabrics 2, thereby reducing the extent of deformation of the outsole 1. Also, the small pieces of fabrics 2 distributed in the vertical direction inside the outsole 1 at least form three layers. Cutting or piercing of shoe soles by sharp objects can be effectively prevented, thereby improving the flex-resistance and puncture-resistance capability of shoe soles. The outsole is transparent. The small pieces of fabrics inside the outsole can render the whole shoe sole a visual effect different from conventional shoe soles. The small pieces of fabrics can also be provided in various colors, giving the shoe sole a very appealing appearance.

In the aforesaid embodiments, a weight ratio of the small pieces of fabrics 2 to the outsole 1 is 1:(1-9). The actual weight ratio can be set according to design needs.

As a preferred embodiment of the aforesaid embodiments, the small pieces of fabrics 2 are strip-shaped; the plurality of small pieces of fabrics 2 are provided along a lengthwise direction of the outsole 1 to converge and withstand the stress of the shoe sole when it is flexed during walking.

As a preferred embodiment of the aforesaid embodiments, each of the small pieces of fabrics is 0.7 cm-1.5 cm long and 0.4 mm-0.6 mm wide, ensuring that the small pieces of fabrics 2 can be ejected out from the nozzle of the injection molding machine during injection molding.

As a preferred embodiment of the aforesaid embodiments, the rubber is thermoplastic rubber (TPR). TPR is a kind of thermoplastic and soft rubber materials having rubber elasticity but without the need to vulcanize and can directly be used for processing (such as injection molding, blow molding, extrusion, etc.). TPR shows great performance in terms of physical and chemical properties, with the advantage of having good processability. It is an excellent material for producing shoe soles.

In the present invention. From the bottom view of the shoe sole (i.e. a view of the shoe sole projected from outside to inside), it is most preferable if the small pieces of fabrics 2 covers 50%-90% of the bottom surface area of the outsole 1.

### Embodiment 3

A method of making the composite shoe sole includes the following steps:

1) Selecting large piece of fabrics, and selecting rubber materials, plastic materials or thermoplastic rubber (TPR) materials, wherein a melting point of the large piece of fabrics is higher than that of the rubber materials, plastic materials or thermoplastic rubber (TPR) materials; and dividing the large piece of fabrics into a plurality of small pieces of fabrics;

2) Weighing the small pieces of fabrics by weight percentage and weighing rubber materials, plastic materials or thermoplastic rubber (TPR) materials by weight percentage; and obtaining a mixture of the small pieces of fabrics and the rubber materials, plastic materials or thermoplastic rubber (TPR) materials through sufficient mixing by using a mixer;

3) Using the mixture to make a shoe sole by injection molding through an injection molding machine.

In the aforesaid injection molding method, the main reason for selecting a large piece of fabrics with a melting point higher than that of the rubber materials, plastic materials or thermoplastic rubber (TPR) materials is to prevent the small pieces of fabrics from carbonization or melting after melting of the rubber materials or plastic materials.

In the aforesaid injection molding method, a weight ratio of the small pieces of fabrics to the rubber materials, plastic materials or thermoplastic rubber (TPR) materials is 1:(1-9). The actual weight ratio can be chosen according to needs.

In the aforesaid injection molding method, materials supplied in granular shapes usually contain different degrees of moisture, different flux and other volatile low molecular-weight substances. In particular, moisture content of TPR with high hygroscopic tendency always exceeds the limit allowed by processing. Thus, the rubber materials, plastic materials or thermoplastic rubber (TPR) are subject to a drying process before hot melting, and moisture content is measured; weight percentage of the moisture is required to be 5% or less.

In the aforesaid method, PU materials can be selected as the plastic materials.

In the process of processing and injection molding, the accuracy of temperature settings is the key to product appearance and performance. Take TPR processing and injection molding as an example. Temperature of the feeding area of the injection molding machine should be set to be fairly low to prevent feed nozzle from clogging and allow the entrained air to escape. When using color concentrates to improve mixed state, temperature in the transition area should be set above the melting point of the color concentrates. Temperature in the area closest to the injection molding nozzle should be set close to the required melt temperature. Thus, tests have shown that temperature setting range in different areas of TPR products is usually as follows: material canister temperature is 160° C. to 210° C. and nozzle temperature is 180° C. to 230° C.

Mold cavity temperature should be set above the condensation temperature in injection molding area, which could prevent stripes from appearing on product surface as a result of moisture contamination of the mold cavity. A higher mold cavity temperature usually results in a longer processing cycle, but could improve the welding seams and product appearance. Thus, the range of mold cavity temperature should be designed to be set between 30° C. to 40° C.

The technical solutions provided in the embodiments of the present invention are described in detail above. Specific embodiments are applied herein to explain the principles and implementation of the embodiments of the present invention. The above-described embodiments are illustrated to aid the reader in understanding the principles of the embodiments of the present invention only; also, for general technical personnel in this field, according to the embodiments of the present invention, specific embodiments and the scope of application are subject to change. In summary, the description provided herein should not be construed as limiting the present invention.

What is claimed is:

1. A composite shoe sole, comprising an outsole which is made of rubber, plastic or thermoplastic rubber (TPR), and a plurality of small pieces of fabrics filled inside the outsole; the outsole and the plurality of small pieces of fabrics are integrally formed.

2. A composite shoe sole according to claim 1, wherein a weight ratio of the small pieces of fabrics to the outsole is 1:(1-9).

3. A composite shoe sole according to claim 1, wherein the small pieces of fabrics are strip-shaped; the plurality of small pieces of fabrics are provided along a lengthwise direction of the outsole.

4. A composite shoe sole according to claim 1, wherein each piece of the small pieces of fabrics is 0.7 cm-1.5 cm long and 0.4 mm-0.6 mm wide.

5. A composite shoe sole according to claim 1, wherein the small pieces of fabrics are made of a large piece of fabrics being crushed by a crusher.

6. A method of making a composite shoe sole includes the following steps:
1) selecting a large piece of fabrics, and selecting rubber materials, plastic materials or thermoplastic rubber (TPR) materials, wherein a melting point of the large piece of fabrics is higher than that of the rubber materials, plastic materials or thermoplastic rubber (TPR) materials; and dividing the large piece of fabrics into a plurality of small pieces of fabrics;
2) weighing the small pieces of fabrics by weight percentage and weighing rubber materials, plastic materials or thermoplastic rubber (TPR) materials by weight percentage; and obtaining a mixture of the small pieces of fabrics and the rubber materials, plastic materials or thermoplastic rubber (TPR) materials through sufficient mixing by using a mixer;
3) using the mixture to make a shoe sole by injection molding through an injection molding machine.

7. A method of making a composite shoe sole according to claim 6, wherein the rubber materials, plastic materials or thermoplastic rubber (TPR) materials are subject to a drying process before injection molding, and moisture content of which is measured; a weight percentage of the moisture content is 5% or less.

8. A method of making a composite shoe sole according to claim 6, wherein the mixture is poured into a mold through the injection molding machine; a temperature of a material canister of the injection molding machine is 160° C.˜210° C.; a temperature of a nozzle of the injection molding machine is 180° C.˜230° C.; a temperature of a mold cavity is 30˜40° C.

9. A method of making a composite shoe sole according to claim 6, wherein the large piece of fabrics are placed in a crusher which operates after setting parameters of the crusher to divide the large piece of fabrics into the plurality of small pieces of fabrics.
